(19) United States
(12) Patent Application Publication
(10) Pub. No.: US 2014/0216045 A1
(43) Pub. Date: Aug. 7, 2014

(54) GAS TURBINE WITH IMPROVED POWER OUTPUT

(71) Applicant: How Kiap Gueh, Blu Coral (SG)

(72) Inventor: How Kiap Gueh, Blu Coral (SG)

(21) Appl. No.: 14/169,706

(22) Filed: Jan. 31, 2014

(30) Foreign Application Priority Data
Feb. 4, 2013 (SG) 201300879-2

(51) Int. Cl. F02C 5/02

(52) U.S. Cl. CPC F02C 5/02
USPC 60/772; 60/39.76

(57) ABSTRACT

The application provides an apparatus for augmenting the power produced by a Brayton-cycle gas turbine system of the type having an air compressor for producing compressed air, a combustor for heating said compressed air and a fuel and producing hot gases, and a gas turbine responsive to the hot gases for driving said air compressor and a load, and for producing exhaust gases. The apparatus comprises a heat exchanger interposed between a source of ambient air and the air compressor, a storage containing R744 refrigerant, connections though which said R744 refrigerant is exchanged with the heat exchanger, and a refrigerant compressor fluidly connected to said storage for circulating at least a portion of the R744 refrigerant

### CROSS-REFERENCE TO RELATED APPLICATIONS

This application claims priority to Singapore application SG201300879-2, filed Feb. 4, 2013, which is incorporated by reference herein in its entirety.

### TECHNICAL FIELD

This invention relates to axial flow gas turbine engines having high efficiency with reduced noxious emissions.

### BACKGROUND OF THE INVENTION

Gas turbine engines include a compression section, a combustion section and a turbine section. An annular flow path for working medium gases extends axially through these sections of the engine. Generally, air enters the compression section where it is compressed, then passes into the combustion section, where the pressurized air is mixed with a fuel (gas or liquid) and burned. The hot pressurized gases which result are then expanded through the turbine section to produce useful work, for example, by driving a generator to produce electricity or by driving a mechanical system such as a gearbox for mechanical shaft power production.

The overall efficiency of a gas turbine is a function of compressor and turbine efficiencies, ambient air temperature, nozzle inlet temperature and type of cycle used. Most gas turbine installations are of the open cycle type using atmospheric air as the working medium and burning relatively clean fuels such as natural gas.

As engines are designed to meet demands for higher power or lower specific fuel consumption, the engines must accommodate:

Increased mass airflow

Increased compression ratio

Increased maximum allowable turbine inlet and outlet temperatures

Improved efficiency of the compressor and turbine sections

Simple cycle gas turbines are relatively inefficient, with almost all losses occurring in the hot exhaust gases. When exhaust gases can be used in a boiler or for process heating, the combination of a turbine with a heat recovery apparatus results in a high efficiency power plant. Another method that results in high efficiency is to integrate the gas turbine with other process requirements.

For maximum efficiency, the turbine section must operate at the highest temperatures possible. However, high temperatures have a negative impact on turbine life. Therefore, to balance these two factors, cooling air is usually injected into the turbine, with the air flowing inside the turbine blades and vanes to cool them while they are in contact with the hot combustion gases. This air is obtained by taking a side-stream of compressed air and injecting it into the turbine section.

In land-based gas turbines, there has been a continuing trend towards improving thermal efficiency while reducing noxious emissions. One idea for improving efficiency involves pre cooling the turbine cooling air prior to its entry into the turbine. Such cooling increases the density of the air and increases the temperature differential, reducing the amount of cooling: air needed to meet turbine cooling requirements. This reduces a loss to the cycle, by increasing the amount of compressed air which passes into the combustor, improving overall efficiency. Typically, this cooling air is obtained by passing the compressed air through a fan cooled heat exchanger for rejecting the heat of compression to the atmosphere.

To meet emission requirements for noxious gases such as nitric oxides (NOx) produced in the combustion cycle, water or steam is injected into the combustor, quenching the hottest combustion zones. Preventing a wide temperature gradient in the combustor would also minimize nitric oxide formation.

In liquid fueled turbines which produce steam by heating water with the hot exhaust gas, separate steam injection into the combustor is typically used for nitric oxide Water may be used with liquid fuels, by mixing with the fuel prior to injection in the combustor. With gaseous fuels such as natural gas, steam is directly injected into the fuel gas, avoiding a separate steam injection manifold. Although steam can be injected separately into the combustor, NOx control is improved if the steam is premixed with the fuel, thereby avoiding hot spots due to insufficient steam/fuel interaction in the combustor. However, the gaseous fuel must be heated prior to mixing to avoid injecting a slug of liquid, i.e. steam condensate, into the combustor, which would cause instabilities in the combustion process or high thermal stress in the combustion chamber.

Part of the fuel heating may be accomplished by directing cooling air exiting the gas turbine enclosure to interchange through a heat exchanger with the entering fuel thereby preheating the fuel up to about 70° C. However, a relatively large heat exchanger is required as the cooling air is at atmospheric pressure and is relatively cool. In addition, further heating, up to about 120° C., must be accomplished by a second heat exchanger to prevent condensation. Therefore, low pressure steam must additionally be used, a thermal energy loss, requiring a separate heat exchanger with associated piping. Alternatively this heating could be done with heat from the turbine exhaust gas, but this reduces the heat available for producing steam.

Another alternative is to use highly superheated steam to heat the steam pipes, thus allowing a degree of cooling without condensation. However, this similarly reduces efficiency and continues the risk of water condensation after mixing with the fuel gas.

### SUMMARY OF THE INVENTION

It is an object of the present invention to provide a gas turbine engine which achieves high efficiency by reducing thermal energy losses.

It is a further object of the present invention to provide a gas turbine engine which reduces noxious emissions.

It is a further object of the present invention to provide a gas turbine engine which requires fewer heat exchangers, reducing the size and cost of auxiliary systems.

### BRIEF DESCRIPTION OF THE DRAWINGS

FIG. 1 is a prior art gas turbine cycle utilizing a fan type cooling air heat exchanger,

FIG. 2 is a gas turbine cycle having an interchanger for preheating a fuel with a compressed air stream prior to steam mixing,

FIG. 3 is illustration of the R744 transcritical cycle chiller, and

FIG. 4 shows the thermodynamic T-s plane graph.

### DETAILED DESCRIPTION OF THE PREFERRED EMBODIMENTS

The main parameters that affect the performance of a gas turbine are the intake air temperature, intake air pressure, and exhaust gases.

The performance of the gas turbine engine is dependent on the mass of air entering the engine. At a constant speed, the compressor pumps a constant volume of air into the engine with no regard for air mass or density. If the density of the air decreases, the same volume of air will contain less mass, so less power is produced, if air density increases, power output also increases as the air mass flow increases for the same volume of air.

Atmospheric conditions affect the performance of the engine since the density of the air will be different under different conditions. On a cold day, the air density is high, so the mass of the air entering the compressor is increased. As a result, higher horsepower is produced. In contrast, on a hot day, or at high altitude, air density is decreased, resulting in a decrease of output shaft power.

There is an obvious drop in the power output as the ambient air temperature increases, if an increase of inlet air temperature from (ISO) condition (15 degrees C.) to a temperature of (30 degrees C.) this would result in 10% decrease in the net power output. This is particularly relevant in tropical climates where the temperature is between 25 and 35 degrees C. (Celsius) through the year.

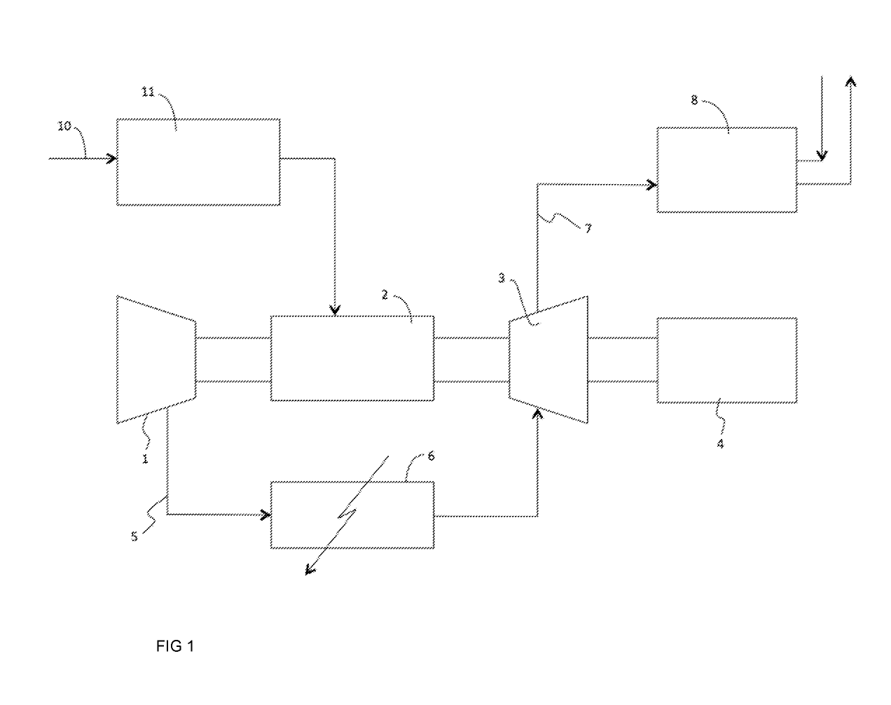

Referring to FIG. 1, a typical gas turbine cycle is shown including a compressor 1, a combustor 2, a turbine 3, with the turbine cycle of the single shaft type for driving a load 4. A compressed air stream 5 is withdrawn from the compressor, cooled in a heat exchanger 6 through interchange with the air and directed into passages in the turbine 3 for cooling the turbine blades and vanes. Heat exchanger 6 may be of the air to air, or air to water to atmospheric air type. In another embodiment the heat exchanger 6 is a CO2 (R744 transcritical cycle chiller plant).

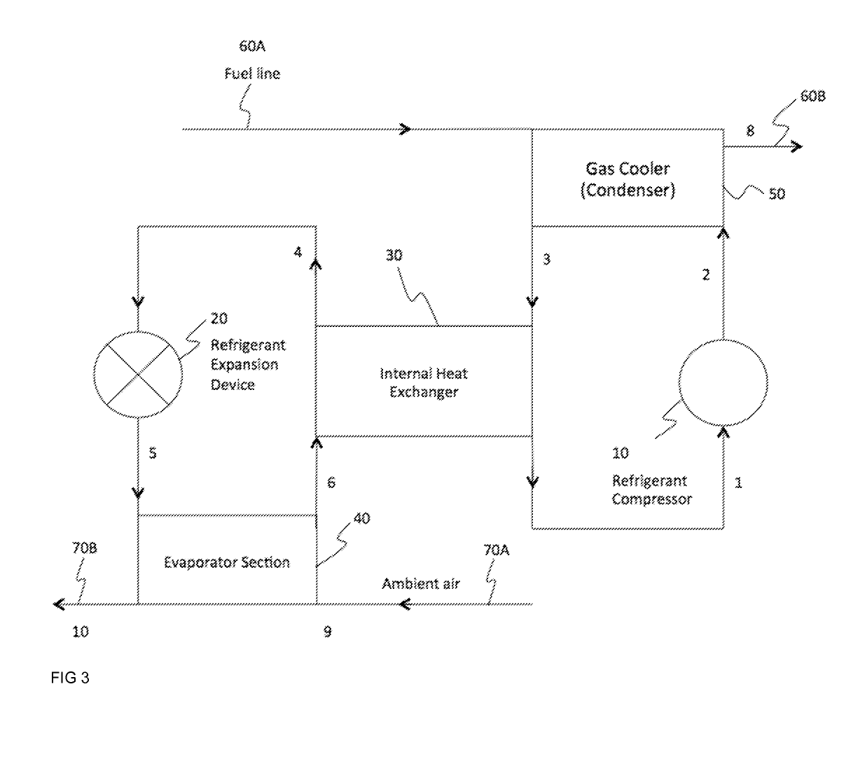

An exhaust stream 7 enters a waste heat boiler (also called a heat recovery steam generator HRSG) 8 to produce steam 9. Preheating either a liquid or gaseous fuel 10, is performed in a heat exchanger 11 operatively and fluidly in communication with a CO2 transcritical cycle chiller plant (of FIG. 3), before directing pre-heated fuel 10 into the combustor 2.

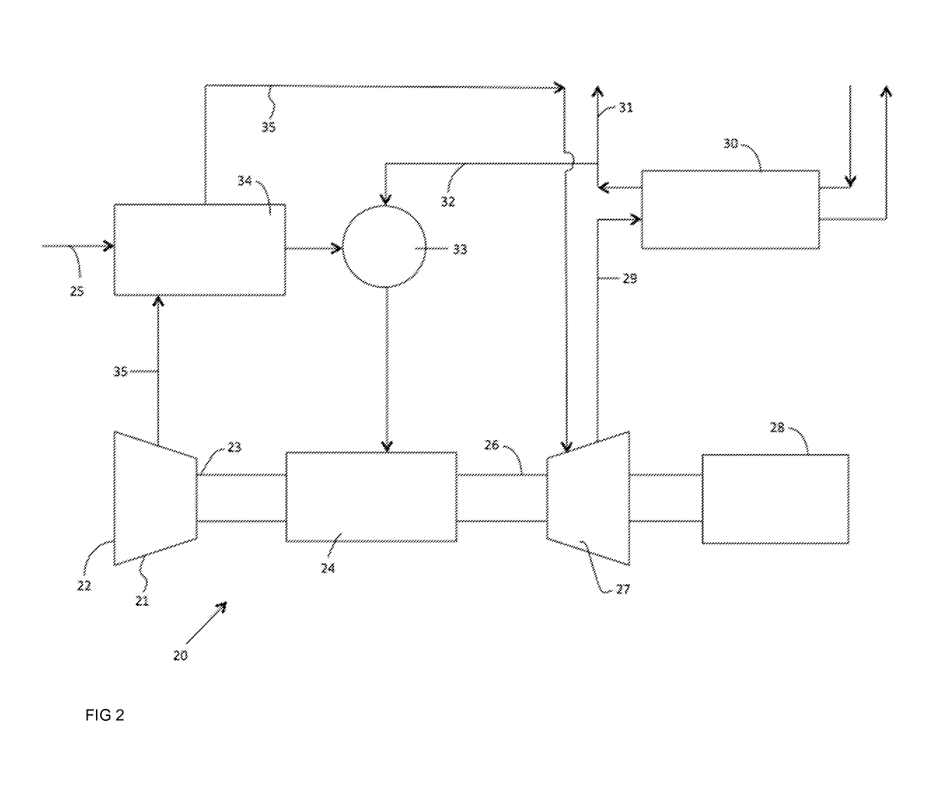

Referring to FIG. 2, a gas turbine 20 having an interchanger for improving the thermal efficiency is shown. A compressor 21 utilizes ambient air as the working medium first passing through an air inlet cooling section (not shown) that cools ambient air to a desired temperature range, the cooled air entering at an end 22 and exiting in a compressed and heated state at 23. The compressed air exits the compressor at a temperature of about 700° F. and above at a pressure of about 230 psia, and above.

In one embodiment of the present invention, ambient air passes through an evaporator section of a chiller plant that is circulating a CO2 (R744) refrigerant to cause the ambient air to be cooled to a desired temperature range, and the cooled ambient air is then directed into compressor section of the gas turbine, the refrigerant R744 operates as a transcritical cycle heat-cooling pump.

In the so-called “traditional” cycle which may use HFCs of HCFCs, the liquefaction process occurs below the critical temperature of the refrigerant hence the name of “sub-critical” cycle. This requires that the refrigerant critical temperature be above the temperature of the medium where heat is rejected. Condensing refrigerant vapor then yields a condensing pressure that is below the refrigerant critical pressure. In this type of cycle, condensing pressure and temperature are linked, by the relationship that depends on the nature of the refrigerant.

In the case of a transcritical cycle, the liquefaction process (or gas cooling) occurs above the critical pressure, while evaporation occurs at a pressure below the critical pressure, as the critical temperature of R744 is around 31° C., the R744 refrigerant discharged from the compressor will be cooled as a “supercritical” fluid because this process occurs at a pressure higher than the critical pressure (74 bars), R744 evaporates at 30 bars and is then compressed, to 120 bars. Upon compression, it reaches a temperature of 120° C. It is then cooled in a “gas cooler”, expanded and is evaporated to complete the cycle.

It is found that besides the inert, nonflammable nature of CO2 as a refrigerant, the entire chiller plant's COP (Coefficient of Performance) can be controlled by varying the rotational velocity (RPM) of the refrigerant compressor device in one instance.

It is also found that the control scheme of the chiller plant can also be implemented by control of the fluid pressure of the CO2 (RZ44) refrigerant flowing within identified sections of the chiller system.

Further, the simultaneous heating and cooling side of the same chiller plant is advantageous for the various embodiments of this present invention.

The CO2 transcritical refrigerant chiller cycle can be described as follows, where and with reference to FIG. 3, saturated vapor at state 6 is superheated to state 1 in the internal heat exchanger and then compressed in the compressor to state 2. The supercritical carbon dioxide at state 2 is cooled in the gas cooler (condenser) to state 3 by rejecting heat to the external fluid (useful heating effect). In the gas cooler (condenser) the heat rejection takes place with a gliding temperature. Carbon dioxide at high pressure is further cooled from 3 to 4 in the internal heat exchanger. After the heat exchanger, the carbon dioxide is expanded, through the expansion device to state 5, which is the inlet to the evaporator. The state of the refrigerant changes from 5 to 6 as it evaporates in the evaporator by extracting heat from the external fluid (useful cooling effect).

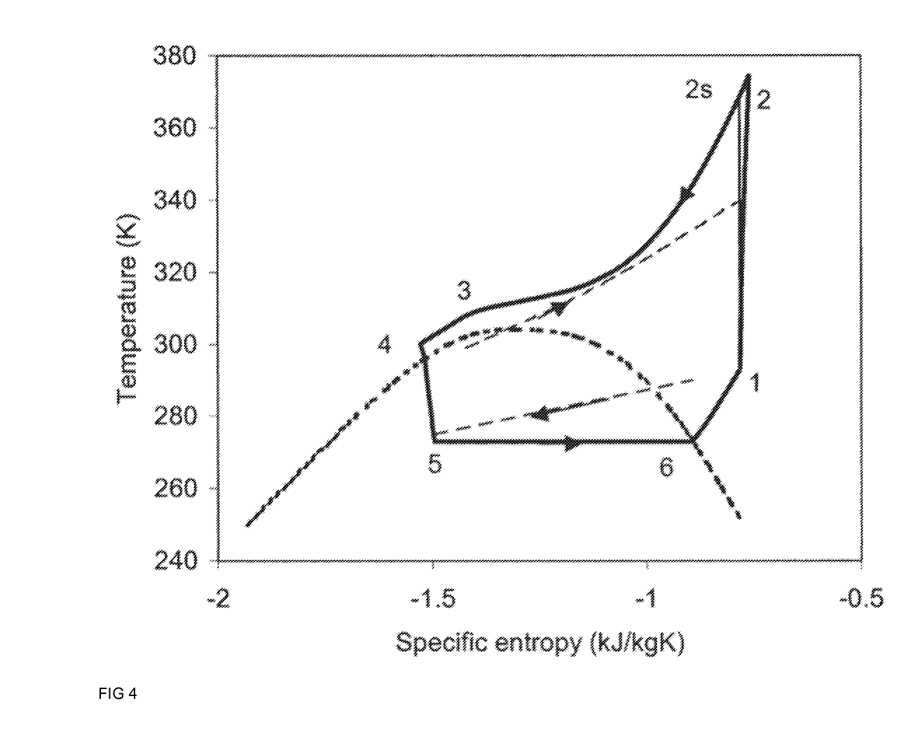

With reference to FIG. 4, process 1-2s is an isentropic compression process, while process 1-2 is the actual compression process. The dotted line below process 2-3 represents the external fluid being heated and dotted line above evaporating process represents the external fluid being cooled.

The compressor 21 supplies the compressed air to a combustor 24. Generally, the combustor may comprise one or more chambers where a fuel 25 is ignited with the compressed air to form a hot combustion gas 26 for driving a turbine 27. The turbine 27 then drives a load 28, and expels a spent exhaust as 29. The exhaust from the turbine enters a heat recovery steam generator 30 which heats water to produce steam 31 while reducing the exhaust gas temperature prior to discharge.

In another embodiment the fuel 25 is pre-heated to a desired temperature range by exchanging heat in a heat exchanger that is also the condenser section of the chiller that is circulating R744 refrigerant.

In one embodiment the Brayton-cycle gas turbine is a single shaft type gas turbine set, in another embodiment the Brayton-cycle gas turbine is a split shaft type gas turbine set. In some other embodiment the Brayton-cycle gas turbine is a combined cycle gas turbine set wherein the exhaust gas flowing out from the turbine section of Brayton-cycle gas turbine is fluidly in communication with a heat recovery steam generator to produce steam to circulate and operate a steam turbine set.

In another embodiment the chiller is provided with at least one refrigerant compressor device that is drawing either electric power or mechanical shaft power from a heat recovery unit that is fluidly connected to the exhaust gas from the turbine section of the gas turbine.

For example, the refrigerant compressor is driven by an electric motor drive.

For example, the refrigerant compressor is driven by a mechanical coupling or gear drive that is connected to the steam turbine set and heat recovery steam generator unit fluidly in communication with the hot exhaust gas flowing out from the turbine section of Brayton-cycle gas turbine set.

In yet another embodiment the mechanical coupling may be connected instead (of the steam turbine set) to the compressor section of the Brayton-cycle gas turbine that is arranged as a single shaft type gas turbine set.

In yet another embodiment the mechanical coupling may be connected instead (of the steam turbine set) to the desired split shaft section of the Brayton-cycle gas turbine that is arranged as a split shaft type gas turbine set.

In yet another embodiment the chiller is provided with a circulating R744 refrigerant and a refrigerant compressor device is driven by mechanical shaft power that is operatively coupled to a heat recovery unit, the heat recovery unit is fluidly in communication with at least a portion of the exhaust combustion gases that is exiting from the turbine section of the Brayton-cycle gas turbine.

In another variation the refrigerant compressor device is mechanically driven by at least one electric motor drive.

In order to reduce emissions, the temperatures within the combustor must be controlled to prevent hot spots which result in the production of nitric oxides (NoX). This is accomplished by adding steam or water to the fuel prior to injection into the combustor, A side stream (steam) 32 is taken and used for mixing with the fuel for nitric oxide suppression. The side stream 32 is added to the fuel 25 in a mixer 33.

Referring still to FIG. 2, the fuel 25 generally arrives at about ambient temperatures from a source of supply such as a natural gas feed main or may be supplied at somewhat elevated temperature after exiting a booster compressor. Typically, the gas may be supplied at from 50 to 540 psi, at temperatures of from 59° to 350° F. Should steam be mixed with the fuel for reducing nitric oxide emissions, it is possible that some of the steam would condense within the pipe and impinge on the combustor wall, causing combustion instability or high thermal stress. Therefore, a preheat interchanger 34 is included in the fuel supply to the mixer 33. In one embodiment, the fuel 25 is preheated. by interchange with a compressed cooling air stream 35. Thus part of the heat of compression is transferred to the fuel and returned to the turbine cycle when injected into the combustor if liquid fuel is used, the degree of fuel heating is limited, to a temperature below the fuel coking limit which is between about 200°-300° F.

In another embodiment the pre-heat interchanger 34 is fluidly in communication with the condenser (gas cooler) section of the CO2 transcritical cycle chiller unit such as the one illustrated in FIG. 3.

The fuel in one embodiment is preheated to a temperature range of between 30 degrees C to 210 degrees C.

Ambient air intake is passed into an inlet cooler that is configured with the chiller plant circulating R744 refrigerant to derive a cooled air stream.

In yet another embodiment, a portion of the cooled air stream 35 continues to the turbine inlet and is used to maintain the turbine blade temperatures within the limits of the materials of construction. Depending on the relative heat loads and initial temperatures of the fuel and compressed air, it may be necessary to have a second heat exchanger for rejecting heat to the atmospheric from the cooling air 35. This heat exchanger would be smaller and of lower cost than it would have been if the fuel heat exchanger were not used.

While the preferred embodiments have been described in relation to a gas turbine engine, it will be understood by those skilled in the art that the various other gas turbines could utilize the high efficiency/low emission gas turbine of the present invention. Consequently, it will be understood by those skilled in the art that various changes or modifications could be made without varying from the present invention.

1. Apparatus for augmenting the power produced by a Brayton-cycle gas turbine system of the type having an air compressor for producing compressed air, a combustor for heating said compressed air and a fuel and producing hot gases, and a gas turbine responsive to the hot gases for driving said air compressor and a load, and for producing exhaust gases, said apparatus comprising:
a heat exchanger interposed between a source of ambient air and the air compressor;
a storage containing R744 refrigerant;
connections though which said R744 refrigerant is exchanged with the heat exchanger; and
a refrigerant compressor fluidly connected to said storage for circulating at least a portion of the R744 refrigerant.

2. Apparatus according to claim 1 wherein said heat exchanger is part of a CO2 transcritical cycle heat pump system.

3. Apparatus according to claim 1 wherein the refrigerant compressor is mechanically driven by an electric motor drive or a steam turbine.

4. Apparatus according to claim 3 wherein the refrigerant compressor is mechanically driven by a steam turbine and wherein a mechanical coupling including a gear drive is connected to the steam turbine.

5. Apparatus according to claim 1 wherein a mechanical coupling is connected to the air compressor.

6. Apparatus according to claim 1 wherein the Brayton-cycle gas turbine system includes a split shaft section and wherein a mechanical coupling is connected to the split shaft section.

7. A gas turbine intake air cooling system for increasing output power of a plant by cooling intake air of the gas turbine using a chiller, wherein:
R744 refrigerant is provided and circulating within the chiller operating a CO2 transcritical heat pump cycle, and intake air is cooled by fluidly passing through at least one evaporator section of the chiller; and
at least one fuel flowing through a fuel line from a fuel source to the combustor section of the gas turbine is pre-heated to a desired temperature range by fluidly passing through at least one condenser section of the chiller prior to flowing into said combustor section of said gas turbine.

8. A method of operating a Brayton-cycle gas turbine system with an increased output power, comprising:
passing ambient air intake through the evaporator section of a CO2 transcritical heat pump cycle chiller plant to cool ambient air intake prior to passing cooled ambient air intake into compressor section of Brayton-cycle gas turbine system; and
passing fuel through the condenser section of said CO2 transcritical heat pump cycle chiller plant to pre-heat fuel prior to passing pre-heated fuel into the fuel inlet section to the combustor section of Brayton-cycle gas turbine system.
